(19) United States
(12) Patent Application Publication
(10) Pub. No.: US 2013/0057811 A1
(43) Pub. Date: Mar. 7, 2013

(54) PIXEL STRUCTURE OF DISPLAY

(71) Applicant: Chia-Hua YU, New Taipei City (TW)

(72) Inventor: Chia-Hua YU, New Taipei City (TW)

(73) Assignee: HANNSTAR DISPLAY CORP., New Taipei City (TW)

(21) Appl. No.: 13/316,945

(22) Filed: Dec. 12, 2011

(30) Foreign Application Priority Data
Sep. 1, 2011 (TW) 100131404

(51) Int. Cl. G02F 1/1335

(52) U.S. Cl. 349/104

(57) ABSTRACT

A pixel structure of a display is disclosed. The pixel structure of the display comprises at least an unit pixel. The unit pixel comprises a plurality of X type light-impenetrable regions and a plurality of light-penetrable regions, or the unit pixel comprises a plurality of X type first light-impenetrable regions, a plurality of X type second light-impenetrable regions and a plurality of light-penetrable regions. The pixel structure of the display of this invention provides good transmittance. In addition, the pixel structure of the display produces four domains or even eight domains. As a result, the problem of color shift can be improved.

### CROSS-REFERENCE TO RELATED APPLICATION

This application claims the benefit of Taiwan Patent Application No. 100131404, filed on Aug. 31, 2011, in the Taiwan Intellectual Property Office, the disclosure of which is incorporated herein in its entirety by reference.

### BACKGROUND OF THE INVENTION

1. Field of the Invention

The present invention relates to a pixel structure of a display, in particular to the pixel structure of a display with a good light transmittance and capable of improving the problem of color shift.

2. Description of the Related Art

In liquid crystal displays, current is passed through a transistor to produce a change of electric field and a deflection of liquid crystal molecules, and then a polarizer is used to determine the brightness of a pixel. Since an upper glass layer is attached with a color filter, each pixel includes three colors: red, blue and green. The pixels producing red, blue and green colors constitute an image screen on a display panel.

With reference to FIG. 1 for a schematic view of a conventional pixel design, a conventional in-plane switching (IPS) pixel design has a single domain only. The single domain refers to a domain where liquid crystal molecules in the light-penetrable regions 11 of the unit pixel 1 have a single inclined direction only. Although this pixel design has a high light transmittance, it also causes a serious problem of color shift.

With reference to FIG. 2 for a schematic view of another conventional pixel design, there are two domains in the IPS pixel design only. The two domains refer to the domains where liquid crystal molecules in the light-penetrable regions 21 of the unit pixel 2 have two inclined directions only. Although this pixel design can improve the problem of color shift, yet it also reduces the light transmittance. Obviously, the aforementioned conventional pixel designs require improvements.

### SUMMARY OF THE INVENTION

In view of the shortcomings of the conventional pixel design, the inventor of the present invention based on years of experience in the related industry to conduct extensive researches and experiments, and finally developed a pixel structure of a display to overcome the shortcomings of the prior art.

It is a primary objective of the present invention to overcome the shortcomings of the prior art by providing a pixel structure of a display with a good light transmittance.

Another objective of the present invention is to provide a pixel structure of a display capable of improving the problem of color shift.

A further objective of the present invention is to provide a pixel structure of a display with a plurality of X type light-impenetrable regions.

To achieve the aforementioned objective, the present invention provides a pixel structure of a display, comprising at least one unit pixel, each having a plurality of X type light-impenetrable regions and a plurality of light-penetrable regions, and each light-impenetrable region comprises a plurality of light-impenetrable sub-regions, wherein an intersection angle is defined between each light-impenetrable sub-region and an axis.

The pixel structure of a display may also comprise at least one unit pixel, each having a plurality of X type first light-impenetrable regions, a plurality of X type second light-impenetrable regions and a plurality of light-penetrable regions, and each first light-impenetrable region comprises a plurality of first light-impenetrable sub-regions, and an intersection angle is defined between each first light-impenetrable sub-region and an axis, and each second light-impenetrable region comprises a plurality of second light-impenetrable sub-regions, and an intersection angle is defined between each second light-impenetrable sub-region and another axis, and the angle values of the intersection angle of each first light-impenetrable sub-region and the axis and the intersection angle of each second light-impenetrable sub-region and the another axis are different.

Compared with the conventional pixel structure of a display, the pixel structure of a display of the present invention has substantially the same or even better light transmittance. In other words, the pixel structure of a display of the present invention has a good light transmittance, and the pixel structure of a display in accordance with the present invention produces four or eight domains, or the liquid crystal molecules in the light-penetrable regions have four or eight inclined directions and are capable of improving the problem of color shift.

To make it easier for our examiner to understand the technical characteristics and effects of the present invention, preferred embodiments together with related drawings are provided for illustrating the present invention as follows.

### BRIEF DESCRIPTION OF THE DRAWINGS

FIG. 1 is a schematic view of a conventional pixel design;

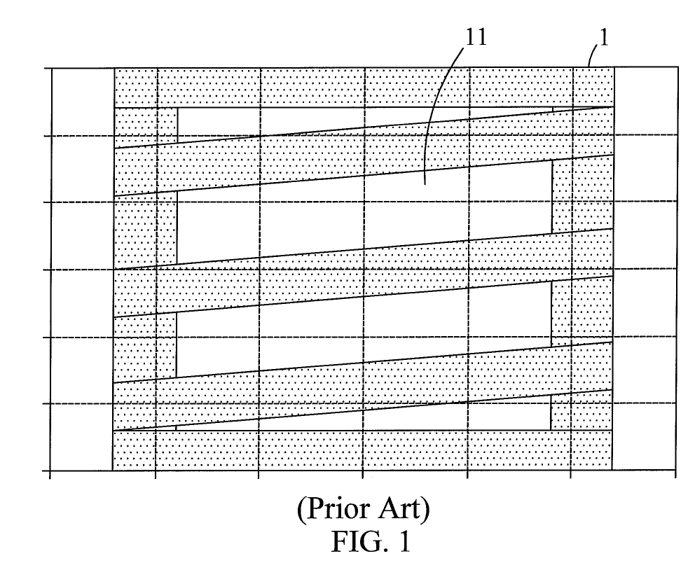

FIG. 2 is a schematic view of another conventional pixel design;

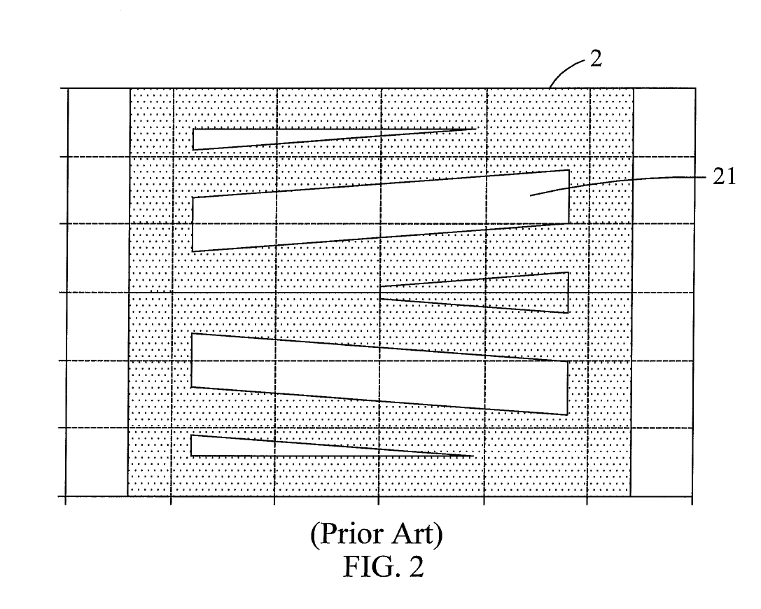

FIG. 3 is a schematic view of a pixel structure of a display in accordance with a first preferred embodiment of the present invention;

FIG. 4 is a schematic view of simulation results of a pixel structure of a display in accordance with the first preferred embodiment of the present invention;

FIG. 5 is a schematic view of a pixel structure of a display in accordance with a second preferred embodiment of the present invention;

FIG. 6 is a schematic view of simulation results of a pixel structure of a display in accordance with the second preferred embodiment of the present invention;

FIG. 7 is a comparative table between the pixel structures of a display of the first and second preferred embodiments of the present invention and a conventional pixel structure of a display; and

FIG. 8 is a comparative schematic diagram of the voltage-transmittance relations between the pixel structure of a display of the present invention and a conventional pixel structure of a display.

### DESCRIPTION OF THE PREFERRED EMBODIMENTS

The technical characteristics of the present invention will become apparent with the detailed description of the preferred embodiments accompanied with the illustration of related drawings as follows. It is noteworthy to point out that same numerals are used for representing respective elements for the description of the preferred embodiments and the illustration of the drawings.

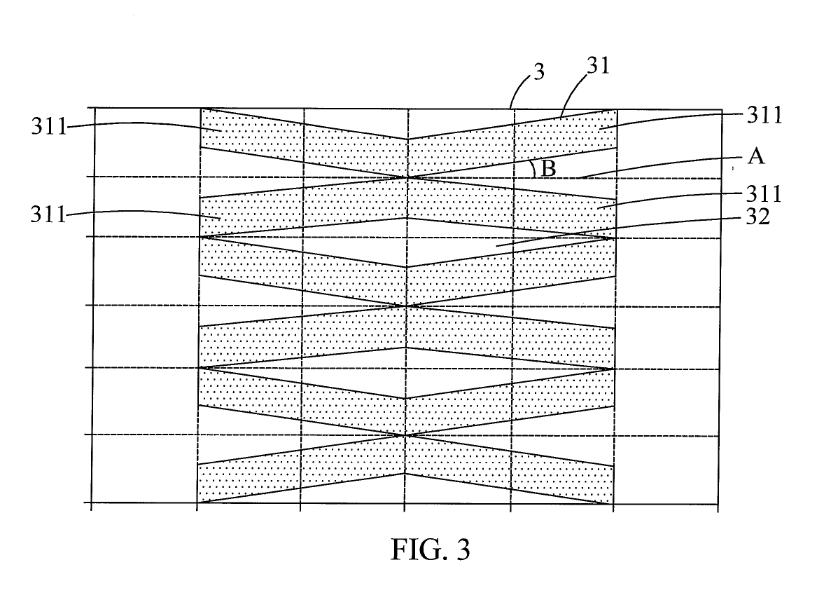

With reference to FIG. 3 for a schematic view of a pixel structure of a display in accordance with the first preferred embodiment of the present invention, the pixel structure of a display comprises at least one unit pixel 3, having a plurality of X type light-impenetrable regions 31 and a plurality of light-penetrable regions 32. Each of the light-impenetrable regions 31 includes a plurality of light-impenetrable sub-regions 311. The light-penetrable regions 32 of the unit pixel 3 are disposed between the light-impenetrable sub-regions 311.

An intersection angle B of each light-impenetrable sub-region 311 and an axis A is preferably below 30 degrees, and the intersection angle B preferably has an angle value ranging from 7 degrees to 30 degrees and more preferably from 7 degrees to 20 degrees. For example, the aforementioned axis A is the x-axis (or horizontal axis) as shown in the figure.

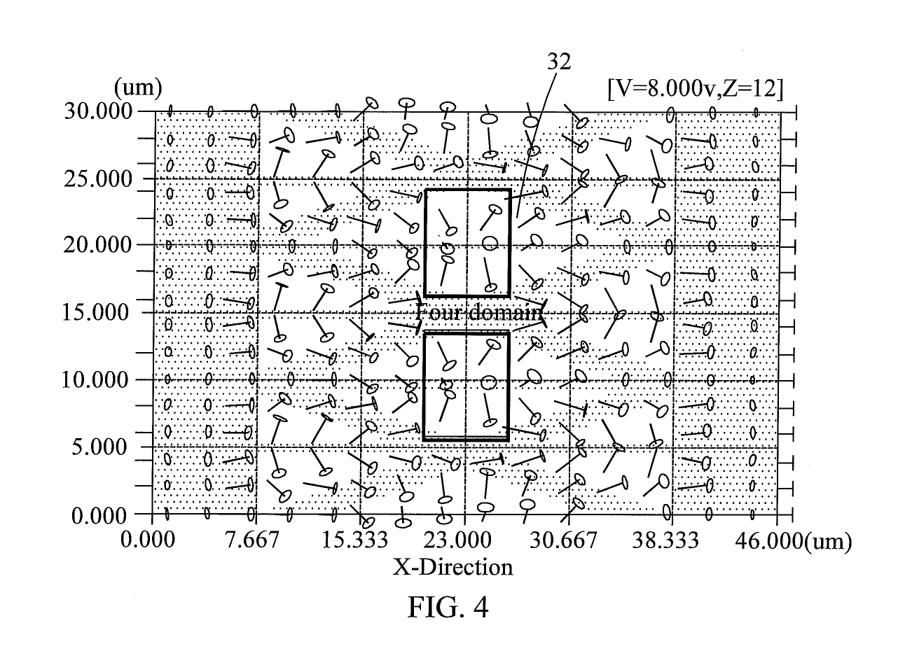

With reference to FIG. 4 for a schematic view of simulation results of a pixel structure of a display in accordance with the first preferred embodiment of the present invention, the pixel structure produces four domains after a voltage is applied. In other words, the liquid crystal molecules in the light-penetrable regions 32 have four inclined directions.

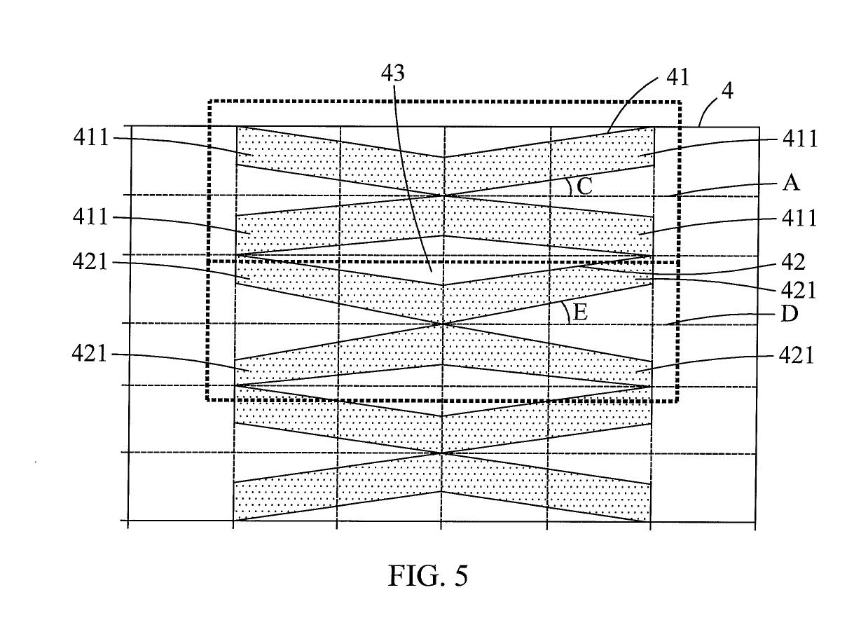

With reference to FIG. 5 for a schematic view of a pixel structure of a display in accordance with the second preferred embodiment of the present invention, the pixel structure comprises at least one unit pixel 4, having a plurality of X type first light-impenetrable regions 41, a plurality of X type second light-impenetrable regions 42 and a plurality of light-penetrable regions 43. Each first light-impenetrable region 41 comprises a plurality of first light-impenetrable sub-regions 411, and each second light-impenetrable region 42 comprises a plurality of second light-impenetrable sub-regions 421. The light-penetrable regions 43 of the unit pixel 4 are disposed between the first light-impenetrable sub-regions 411 or the second light-impenetrable sub-regions 421.

The intersection angle C of each first light-impenetrable sub-region 411 and the axis A is preferably below 30 degrees. The intersection angle E of each second light-impenetrable sub-region 421 and the axis D is preferably below 30 degrees. The angle value of the intersection angle C or the intersection angle E preferably falls within a range from 7 degrees and 30 degrees, and more preferably between 7 degrees and 20 degrees. The angle values of the intersection angle C and the intersection angle E are different. For example, the intersection angle C of this preferred embodiment is equal to 7 degrees, and the intersection angle E is equal to 13 degrees. The axis A or axis D is an axis (or a horizontal axis) parallel to the x-axis as shown in the figure.

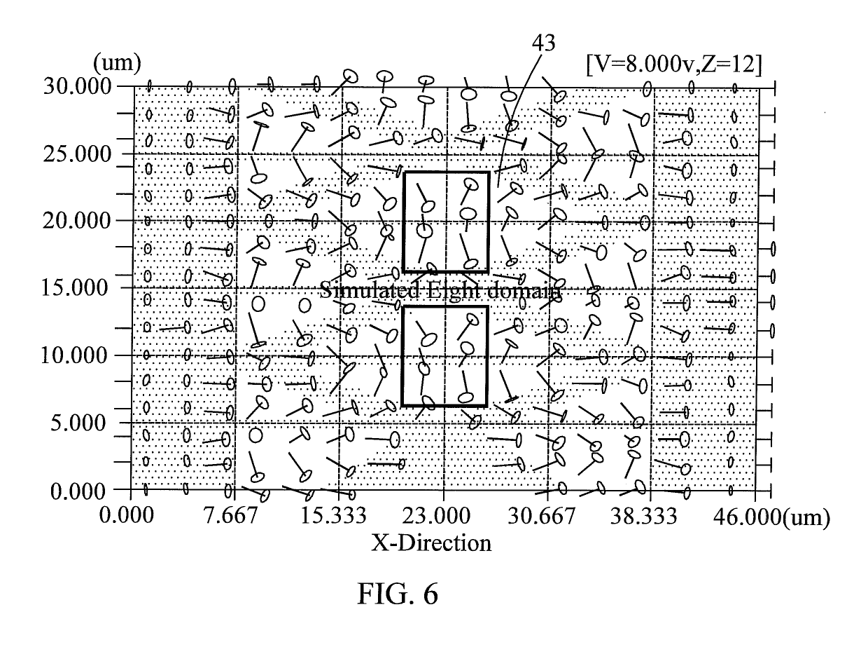

With reference to FIG. 6 for a schematic view of simulation results of a pixel structure of a display in accordance with the second preferred embodiment of the present invention, the pixel structure produces eight domains after a voltage is applied. In other words, the liquid crystal molecules in the light-penetrable regions 43 have eight inclined directions.

It is noteworthy to point out that the pixel structure of a display in accordance with the first preferred embodiment or the second preferred embodiment of the present invention is applicable for the IPS display or a fringe field switching (FFS) display.

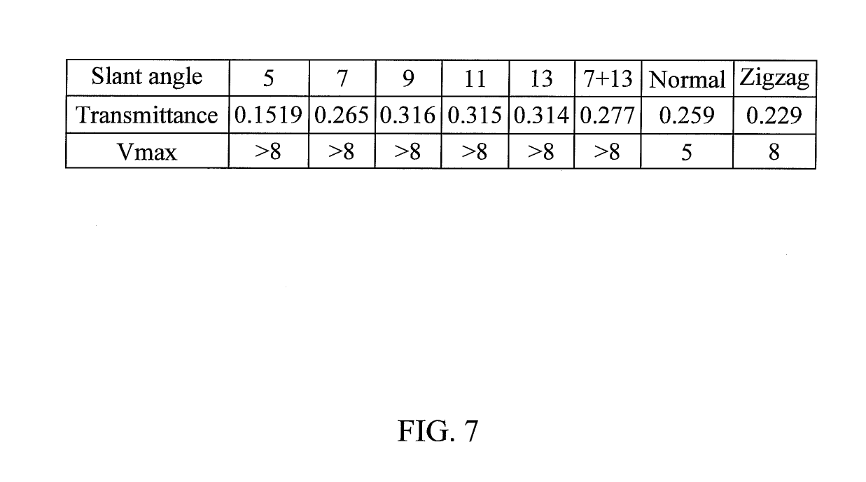

With reference to FIG. 7 for a comparative table between the pixel structures of a display of the first and second preferred embodiments of the present invention and a conventional pixel structure of a display, the pixel structure of a display of the first preferred embodiment in accordance with the present invention has a light transmittance substantially equal to the conventional pixel structure of a display. In the pixel structure of a display of the second preferred embodiment of the present invention, wherein the intersection angle C is equal to 7 degrees, and the intersection angle E is equal to 13 degrees, the light transmittance is even better than that of the conventional pixel structure.

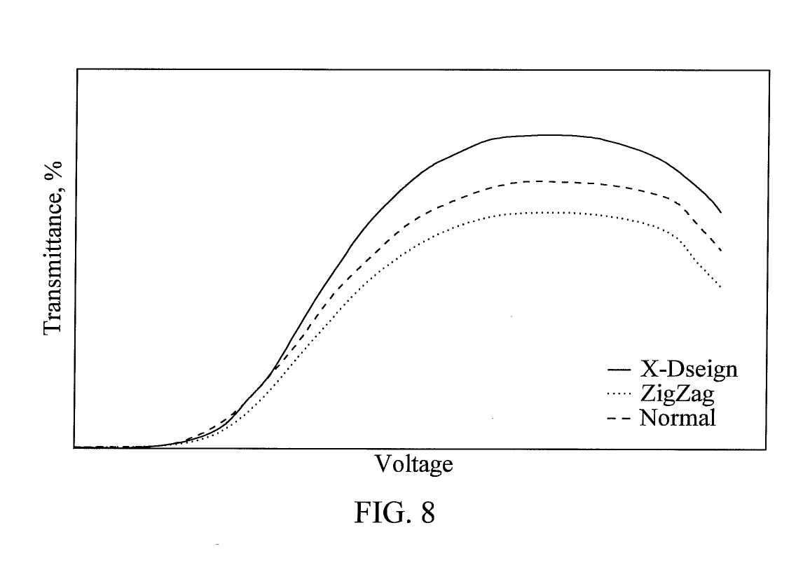

With reference to FIG. 8 for a comparative schematic diagram of the voltage-transmittance relations between the pixel structure of a display of the present invention and a conventional pixel structure of a display, the pixel structure of a display of the present invention has a better light transmittance than the conventional pixel structure of a display under the condition of the same voltage.

In summation, the pixel structure of a display of the present invention has one or more of the following advantages:

1. Good light transmittance: The pixel structure of a display in accordance with the first preferred embodiment of the present invention has substantially the same light transmittance as the conventional pixel structure of a display, and the pixel structure of a display in accordance with the second preferred embodiment of the present invention has even better light transmittance than the conventional pixel structure of a display.

2. Improving the problem of color shift: The pixel structure of a display of the present invention produces four or eight domains. In other words, the liquid crystal molecules in the light-penetrable regions have four or eight inclined directions capable of improving the problem of color shift.

While the means of specific embodiments in present invention has been described by reference drawings, numerous modifications and variations could be made thereto by those skilled in the art without departing from the scope and spirit of the invention set forth in the claims. The modifications and variations should in a range limited by the specification of the present invention.

What is claimed is:

1. A pixel structure of a display, comprising:
at least one unit pixel, each comprises a plurality of X type light-impenetrable regions, and each light-impenetrable region comprises a plurality of light-impenetrable sub-regions, and an intersection angle being defined between each light-impenetrable sub-region and an axis; and
a plurality of light-penetrable regions, disposed between the light-impenetrable sub-regions.

2. The pixel structure of a display as recited in claim 1, wherein the unit pixel produces four domains, and a plurality of liquid crystal molecules in the light-penetrable regions have four inclined directions.

3. The pixel structure of a display as recited in claim 1, wherein the intersection angle of each light-impenetrable sub-region and the axis has an angle value falling within a range from 7 degrees to 30 degrees.

4. The pixel structure of a display as recited in claim 3, wherein the axis is a horizontal axis.

5. A pixel structure of a display, comprising:
at least one unit pixel, each comprises a plurality of X type first light-impenetrable regions, and each first light-impenetrable region comprises a plurality of first light-impenetrable sub-regions, and an intersection angle being defined between each first light-impenetrable sub-region and an axis;
a plurality of X type second light-impenetrable regions, each including a plurality of second light-impenetrable sub-regions, and an intersection angle being defined between each second light-impenetrable sub-region and another axis, and the another axis is parallel to the axis; and
a plurality of light-penetrable regions, disposed between the first or second light-impenetrable sub-regions, wherein the intersection angle of each first light-impenetrable sub-region and the axis and the intersection angle of each second light-impenetrable sub-region and the another axis have different angle values.

6. The pixel structure of a display as recited in claim 5, wherein the unit pixel produces eight domains, and a plurality of liquid crystal molecules in the light-penetrable regions have eight inclined directions.

7. The pixel structure of a display as recited in claim 5, wherein the intersection angle of each second light-impenetrable sub-region and the axis has an angle value falling within a range from 7 degrees to 30 degrees.

8. The pixel structure of a display as recited in claim 7, wherein the intersection angle of each second light-impenetrable sub-region and the another axis has an angle value falling within a range from 7 degrees to 30 degrees.

9. The pixel structure of a display as recited in claim 8, wherein the axis is a horizontal axis.

10. The pixel structure of a display as recited in claim 8, wherein the another axis is a horizontal axis.
